(19) United States
(12) Patent Application Publication
(10) Pub. No.: US 2026/0185468 A1
(43) Pub. Date: Jul. 2, 2026

(54) SYSTEM AND METHOD FOR DISTINGUISHING BETWEEN A TIMING CHAIN JUMP AND A LOCK-UP OF AN ACTUATOR IN A VARIABLE VALVE TIMING DEVICE

(71) Applicant: Vitesco Technologies GmbH, Regensburg (DE)

(72) Inventors: Stéphane ELOY, Toulouse (FR); Fabien JOSEPH, Toulouse (FR)

(73) Assignee: Vitesco Technologies GmbH, Regensburg (DE)

(21) Appl. No.: 18/728,613

(22) PCT Filed: Jan. 31, 2023
(86) PCT No.: PCT/EP2023/052244

§ 371 Date: Jul. 12, 2024

(30) Foreign Application Priority Data
Feb. 2, 2022 (FR) FR2200928

(51) Int. Cl. F01L 1/348; F01L 13/00

(52) U.S. Cl. CPC F01L 1/348; F01L 2013/10; F01L 2800/11; F01L 2820/041; F01L 2820/042

(57) ABSTRACT

A motor vehicle variable valve timing control system, including: a position-learning module for determining positions of teeth of at least one camshaft target; a stability-estimating module, for determining whether a variable valve timing actuator has been in a stable setpoint position for a given length of time; modules for determining and compensating for a chain jump, taking the velocity of the variable valve timing into consideration when the actuator has not been in the stable setpoint position for a given length of time; a jammed-determination module, for concluding that a variable valve timing actuator has jammed if the learned-position comparisons show an offset greater than a lower threshold angle; and a chain-jump locating module. Also disclosed is a method and a program based on such a system.

This application is the U.S. National Phase Application of PCT International Application No. PCT/EP2023/052244, filed Jan. 31, 2023, which claims priority to French Patent Application No. FR2200928, filed Feb. 2, 2022, the contents of such applications being incorporated by reference herein.

### DESCRIPTION

### Field of the Invention

The invention relates to the field of systems and methods for controlling elements of a motor vehicle internal combustion engine, particularly systems and methods for distinguishing between a timing chain jump and a lock-up of a variable valve timing actuator.

### Background of the Invention

Variable valve timing (widely known by its English abbreviation VVT) is a technology used for varying a number of parameters in an internal combustion engine: the timing of the valve opening/closing events (VVT), the duration of the valve opening/closing events and/or the valve lift (variable valve lift) of the intake and exhaust valves. These parameters vary chiefly as a function of demand for speed, load and acceleration.

The advantages of variable valve timing are high torque at low speed, high power at high speed, better efficiency (enabling the engine to operate on the Atkinson cycle and a reduction in pumping losses), and reduced pollutant emissions.

Control of variable valve timing uses equidistant control edges of a camshaft target in order to provide setpoint control. Specifically, the distance between these control edges is compared against a measurement made by a crankshaft sensor. If the distances are not equal, that means that the camshaft is moving relative to the crankshaft; if they are equal, that means that the setpoint has been achieved.

The camshaft teeth are not situated in the theoretical position. Because of mechanical tolerances, there is always a difference. Learning is used to compensate for this using software strategies.

The strategy consists in checking the status of a variable valve timing actuator. If this actuator is locked, the position of the teeth is acquired, a mean value is calculated, and the result is the learning.

If stability is not achieved during learning, that means that the actuator was moving, and therefore the result is rejected.

When the difference between two consecutive learnings exceeds a threshold value (for example 20° CRK, which is to say 20° of crankshaft angle), that means that the timing chain has jumped and variable valve timing therefore needs to be disabled in order to protect the engine, as there is a risk of the valve touching the piston. The threshold value may vary according to the number of teeth on the crankshaft used: 18 teeth imply a jump of 20° CRK (considering 360° for 18 crankshaft teeth, namely 360/18=20°).

### SUMMARY OF THE INVENTION

### Technical Problem to be Addressed

Increasing numbers of electrical variable valve timing actuators are being integrated into engines these days.

The electric motor of the variable valve timing actuator may happen to be faulty, leaving the variable valve timing jammed in a non-locked position.

Stability is achieved, and a misdiagnosis of a jump of the chain on the camshaft will be wrongly detected.

A timing chain jump is not a problem that can be resolved by itself. This is because either the crankshaft is accelerating too quickly and the timing chain is not engaging correctly with its timing sprocket, or a camshaft is offering excessive resistance so that the chain is slipping on this sprocket. This timing chain is unable to return to the correct position without the intervention of a technician. The fault warning light will therefore come on when it should not.

However, the lock-up problem could be resolved by means of an on/off switch for the power supply to the variable valve timing actuator.

In addition, a diagnosis is made only when a timing-variation process is in progress, which is to say when the variable valve timing actuator is in a locked position, and therefore potentially long after the timing chain jump has occurred.

Technical Solution An aspect of the invention makes it possible to distinguish a true chain jump on the camshaft from a jammed variable valve timing system.

It also allows the chain jump to be compensated so as not to destroy the engine.

It further makes it possible to determine whether a previously jammed variable valve timing actuator has rectified itself.

To this end, an aspect of the invention relates to a system for controlling variable valve timing for a motor vehicle mechanical system comprising one or more camshafts connected to a crankshaft and one or more variable valve timing actuators each associated with a respective camshaft, the control system comprising:
a position-learning module for determining, for each camshaft, positions of teeth of a corresponding camshaft target,
a stability-estimating module for determining, for each variable valve timing actuator, whether said actuator has been in a stable setpoint position for a given length of time,
a learnings comparison module for determining, for each variable valve timing actuator situated in the stable setpoint position for a given length of time, whether a new determination of the positions of teeth of the target of the corresponding camshaft has become offset with respect to a former determination of said positions by an offset angle greater than a chain-jump angle,
a weighted-learnings comparison module for determining, for each variable valve timing actuator not situated in the stable setpoint position for a given length of time, whether the new determination of the positions of teeth of the target of the corresponding camshaft to which a new actuator setpoint has been added has become offset with respect to the former learned position to which a former actuator setpoint had been added by an offset angle greater than the chain-jump angle, taking the velocity of the variable valve timing into consideration,
a chain jump-compensating module for adding the offset angle to the new actuator setpoint, for each variable valve timing actuator and when the new determination of the positions of teeth is offset by an offset angle greater than the chain-jump angle,
an actuator-jammed determination module employed, for each variable valve timing actuator and when the new determination of the positions of teeth is offset by an offset angle smaller than the chain-jump angle, to determine whether said offset angle is greater than a lower threshold angle,
a jammed-concluding module connected to the actuator-jammed determination module, to conclude that the variable valve timing actuator has jammed if the offset angle is greater than said lower threshold angle,
when there are several camshafts, a chain-jump locating module, using the respective offset angle for each camshaft to locate the chain jump, the chain jump being located:
   on the camshaft associated with an offset angle greater than the chain-jump angle, with the other camshaft(s) respectively being associated with an offset angle less than the chain jump, or
   on the crankshaft when there are several camshafts all associated with an offset angle greater than the chain-jump angle.

In the context of an aspect of the invention, the term “module” is notably intended to mean a functional entity that groups together one or more electronic and/or information-technology means for the purposes of performing a given function.

Advantageously, said chain-jump angle corresponds more or less to a distance separating two teeth of the timing sprocket with which the timing chain engages, or in other words a distance, in absolute value, separating two teeth of the timing sprocket with which the timing chain engages.

Advantageously, an aspect of the invention makes it possible to distinguish between a true timing chain jump and a jamming of a variable valve timing actuator by using the learning of the position of the camshaft teeth, and the aforementioned modules.

It also allows the chain jump to be compensated so as not to destroy the engine, by using the compensation module. In this way, the engine is protected.

The main advantage is that the variable valve timing can continue to be used even if a chain jump has been detected.

The diagnostics are robust in relation to sporadic jamming of the electric actuator and enable a return to nominal mode.

Throughout this text, “° CRK” denotes an angular degree of rotation of the crankshaft, or crank angle.

In particular, the chain-jump angle is between 19 and 21° CRK, for example 20° CRK. This means it can be suitable for specific mechanical systems used generally, namely crankshafts having an 18-tooth timing sprocket for engaging with the timing chain.

As a preference, the lower threshold angle is comprised between 2 and 6° CRK, for example 5° CRK.

In a variant, the stability-estimating module is configured to determine, for each variable valve timing actuator, that said actuator is in a stable setpoint position if the teeth are within a range of plus or minus 1 degree with respect to an actuator setpoint.

In particular, the given length of time is from 3 to 8 seconds, for example 5 seconds.

In a preferred variant, the control system further comprises
an engine-cylinders fuel-injection cut-off evaluation module for evaluating whether a phase of cutting off the injection of fuel has been reached,
a jam verification module for verifying, when it has been determined that a phase of cutting off the injection of fuel has been reached and for each variable valve timing actuator, whether said variable valve timing actuator has jammed,
a control module for commanding, for each variable valve timing actuator, a movement of said variable valve timing actuator through a chain-jump angle corresponding more or less to a distance separating two teeth on the timing sprocket with which the timing chain engages,
a position-verification module for verifying, for each variable valve timing actuator, if the position of said variable valve timing actuator has been modified by the movement,
a shift-verification module for verifying, for each variable valve timing actuator for which it has been determined that the position has been modified by the movement, if the position has varied by an amount greater or less, in terms of absolute value, than the chain-jump angle,
a not-jammed-concluding module for concluding that the variable valve timing actuator is no longer jammed but that a problem persists in the event that the position has varied by an amount greater, in terms of absolute value, than the chain-jump angle,
a self-rectified-concluding module for concluding that the variable valve timing actuator has rectified itself, in the event that the position has varied by an angle less, in terms of absolute value, than said chain-jump angle and that the position has returned to an earlier learned value.

This makes it possible to limit incorrect detections and, therefore, activation of the fault warning light. Furthermore, it makes it possible to avoid the need to consult a technician.

An aspect of the invention further relates to a method for controlling variable valve timing for a motor vehicle mechanical system comprising one or more camshafts connected to a crankshaft and one or more variable valve timing actuators each associated with a respective camshaft, the control method comprising:
a learning step for determining, for each camshaft, positions of teeth of a corresponding camshaft target, for positions of camshaft teeth, for camshaft targets,
a stability-estimating step for determining, for each variable valve timing actuator, whether said actuator has been in a stable setpoint position for a given length of time,
a learnings-comparison step for determining, for each variable valve timing actuator not situated in the stable setpoint position for a given length of time, whether a new determination of the positions of teeth of the target of the corresponding camshaft has become offset with respect to a former determination of said positions by an offset angle greater than a chain-jump angle,
a weighted-learnings comparison step for determining, for each variable valve timing actuator not situated in the stable setpoint position for a given length of time, whether the new determination of said positions of teeth of the target of the camshaft to which a new actuator setpoint has been added has become offset with respect to a former determination of said positions of teeth of the target of the camshaft to which a former actuator setpoint had been added by an offset angle greater than the chain-jump angle, taking the velocity of the variable valve timing into consideration,
a chain jump-compensating step for adding the offset angle to the new actuator setpoint, for each variable valve timing actuator and when the new determination of the positions of teeth is offset by an offset angle greater than the chain-jump angle,
an actuator-jammed determination step employed, for each variable valve timing actuator and when the new determination of the positions of teeth is offset by an offset angle smaller than the chain-jump angle, to determine whether said offset angle is greater than a lower threshold angle,
a jammed-concluding step for concluding that the variable valve timing actuator has jammed if the offset angle is greater than said lower threshold angle,
when there are several camshafts, a chain-jump location step using the respective offset angle for each camshaft to locate the chain jump, the chain jump being located:
   on the camshaft associated with an offset angle greater than the chain-jump angle, with the other camshaft(s) respectively being associated with an offset angle less than the chain jump, or
   on the crankshaft when there are several camshafts all associated with an offset angle greater than the chain-jump angle.

According to one variant, the control method further comprises
an engine-cylinders fuel-injection cut-off evaluation step for evaluating whether a phase of cutting off the injection of fuel has been reached,
a jam verification step for verifying, when it has been determined that a phase of cutting off the injection of fuel has been reached and for each variable valve timing actuator, whether said variable valve timing actuator has jammed,
a control a step for commanding, for each variable valve timing actuator, a movement of said variable valve timing actuator through a chain-jump angle corresponding more or less to a distance separating two teeth on the timing sprocket with which the timing chain engages,
a position-verification step for verifying, for each variable valve timing actuator, if the position of said variable valve timing actuator has been modified by the movement,
a shift-verification step for verifying, for each variable valve timing actuator for which it has been determined that the position has been modified by the movement, if the position has varied by an amount greater or less than the chain-jump angle,
a not-jammed-concluding step, for concluding that the variable valve timing actuator is no longer jammed but that a problem persists, in the event that the position has varied by an amount approximately equal to the chain-jump angle,
a self-rectified-concluding step for concluding that the variable valve timing actuator has rectified itself, in the event that the position has varied by an angle less, in terms of absolute value, than the chain-jump angle and that the position has returned to an earlier learned value.

Another subject of an aspect of the invention relates to a computer program comprising program code instructions for carrying out the steps of the control method according to an aspect of the invention, when said program is run on a computer.

An aspect of the invention also relates to a vehicle comprising a control system according to an aspect of the invention.

### BRIEF DESCRIPTION OF THE DRAWINGS

Aspects of the invention will be further detailed through the description of nonlimiting embodiments, and on the basis of the attached figures which illustrate preferred variants of the invention and among which:

FIG. 1 schematically depicts a mechanical system linking a crankshaft to two camshafts, suitable for implementation of an aspect of the invention;

FIG. 2 schematically depicts a method and a system according to a first preferred variant of an aspect of the invention; and

FIG. 3 schematically depicts additional modules and steps of a method and of a system according to an aspect of the invention.

### DETAILED DESCRIPTION OF EXEMPLARY EMBODIMENTS

An aspect of the invention relates to a variable valve timing control system and method for a motor vehicle mechanical system.

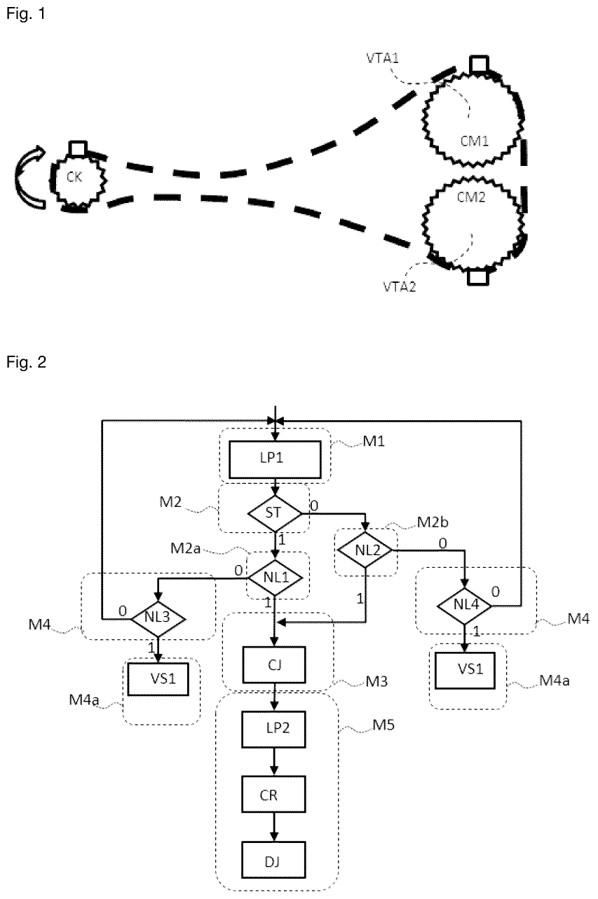

This type of motor vehicle mechanical system may be illustrated by FIG. 1. In the example illustrated, the mechanical system comprises two camshafts CM1, CM2 connected to a crankshaft CK and variable valve timing actuators VTA1, VTA2 associated with the camshaft CM1 and CM2 respectively, in an arrangement that is known per se.

In this context, it is known practice to determine positions of the control edges of a camshaft target.

Each camshaft target is a disk equipped on its circumference with teeth that are spaced irregularly but on which it is possible to find a fixed distance of 720° divided by the number of cylinders between two changes in levels of teeth (which may or may not be consecutive), for example 240° for a 3-cylinder engine, or 180° for a 4-cylinder engine.

An aspect of the invention comprises first of all, for each camshaft itself associated with a respective actuator, a step of learning the position of the teeth of the camshaft target, and a step of determining the stable or non-stable status of each of the corresponding variable valve timing actuators VTA1 and VTA2, respectively.

The status is said to be stable when the actuator has been in a stable setpoint position for a given length of time (locked in position or less than +/−1° from the setpoint for a given length of time for example of 5 s).

With reference to FIG. 2, it is possible to speak of a position-learning module M1 for learning the positions of the teeth of camshafts CM1, CM2, and of a corresponding position-learning step LP1. It is also possible to define an offset-estimating module M2 (offset being with respect to a setpoint position), or in other words a module for estimating the stability of each actuator. In the same way, it is possible to define an offset-estimating step ST (offset being with respect to a setpoint position), or in other words a step of estimating the stability of each actuator.

In each learning operation, the mean of an offset for all of the teeth is calculated for each camshaft CM1, CM2 (mean of the acquisitions for each tooth).

The differences compared with the former position-learning mean values are calculated and analyzed.

If one of the differences is greater than the chain-jump angle corresponding to a jumping of the chain (−20° CRK in the example), this means that a chain jump has occurred.

In particular, in the event that each variable valve timing actuator VTA1, VTA2 is situated in the stable setpoint position for a given length of time, a learnings comparison module M2a determines if a new learning of the positions of teeth of the target of the corresponding camshaft has been offset with respect to a former learning of said positions, by an offset angle greater than a chain-jump angle.

With reference to FIG. 2, a step NL1 may be defined for these comparisons and differences. The step NL1 is executed by the learnings comparison module M2a in order to determine whether the new learned position is offset with respect to the former learned position. The step NL1 is the result of an affirmative outcome to step ST.

According to whether the difference appears in:
The adaptive value of a first camshaft CM1 only: this means that the chain jump has occurred on a tooth of the first camshaft CM1.
The adaptive value of a second camshaft CM2 only: this means that the chain jump has occurred on a tooth of the second camshaft CM2.
Both the adaptive values of the first and second camshafts CM1, CM2: this means that the chain jump has occurred on a tooth of the crankshaft CK.

As soon as this chain jump is detected, the corresponding actuator VTA1 will be commanded to compensate for the chain jump, and thus protect the engine, and continue to operate the variable valve timing. To this end, a chain-jump compensating module M3 and a compensation step CJ may also be defined. In order to achieve this, all of the actuator setpoints for which a difference has been detected will be increased by the previously-calculated difference.

Each time a camshaft target cam control edge is received, the actuator setpoint and the measured shift of the actuator are recorded.

It is also possible to define a chain-jump locating module M5 and a chain-jump location step, including a step LP2 of awaiting new learnings regarding all the available camshafts CM1, CM2; a step CR of comparing the results of the learning operations; and a step DJ of determining the location of the chain jump.

The shifting of the actuator VTA1 is the angular difference between the acquisition of the cam control edge and the theoretical position of said cam control edge when the actuator VTA1 is in the reference position, corrected by the last valid adaptation of the camshaft (consistent with the previous value without any jamming of the actuator or jumping of the chain), already comprising a compensation for the effect of speed and the effects of temperature.

In instances in which a variable valve timing actuator VTA1, VTA2 has not been situated in the stable setpoint position for a given length of time, an aspect of the invention proposes implementing, for this actuator, a step NL2 of comparing weighted learnings, using a weighted-learnings comparison module M2b. The step NL2 then takes the place of the step NL1 mentioned above.

It involves determining if a new learning of the positions of teeth of the target of the corresponding camshaft, to which a new actuator setpoint (sp2) has been added, is offset with respect to a former learning of said positions of teeth of the target of the corresponding crankshaft, to which a former actuator setpoint (sp1) has been added, by an offset angle greater than a chain-jump angle taking the velocity of the variable valve timing into consideration.

In practice, the difference between the actuator setpoints for the last two cam control edges is calculated (this being denoted as Δsp=sp2−sp1). In other words, the difference between the actuator setpoints for the two learning operations considered is calculated (this being denoted as Δsp=sp2−sp1).

The difference between the measured shifts of the actuator for the two last cam control edges is calculated (and denoted Δmeas). In other words, the difference between the measured shifts of the actuator for the two learning operations considered is calculated (and denoted as Δmeas).

If the actuator setpoint has been updated between two events of receiving camshaft target control edges considered (or in other words between the two learning operations considered), an estimate of the shifting of the actuator is calculated from the speed of the actuator and from the length of time between receipt of the two cam control edges considered (and this is denoted Δest).

The quantities Δmeas and Δest together define the effect of the velocity of the variable valve timing, situated in an unstable position between the two position learning operations (in practice, this corresponds to a moment at which the variable valve timing is in the process of changing over from one position to the other).

On each event of receiving a cam control edge, the differences Δsp and (Δmeas+Δest) are compared. The result is used in the step NL2 of comparing learnings weighted by said setpoints and variable valve timing velocities. The step NL2 is executed by the learnings comparison module M2b in order to determine if the new learned position to which a new actuator setpoint has been added is offset with respect to the former learned position to which a former actuator setpoint had been added. In particular, the velocity makes it possible to determine a corrective angle which is also added to the offset angle. If the differences Δsp and (Δmeas+Δest) are equivalent, no chain jump is detected. If the quantities differ by approximately one chain-jump angle value, that means that a chain jump is detected, and the actuator setpoint needs to be corrected immediately to incorporate this value, so as to protect the engine. Specifically, if the actuator shifts far more rapidly than the actuator mechanics will allow, the chain may jump.

It is possible to locate the chain jump, in the same way as detailed hereinabove for the case where each variable valve timing actuator has been situated in the stable setpoint position for a given length of time.

The advantage of this new strategy is that of verifying that the actuator is able to compensate for the chain jump (so that the adaptive camshaft value has to return to the earlier values) and also that an uncorrected camshaft chain jump will no longer be diagnosed.

When a chain jump is detected, a chain-jump compensating module M3 adds the offset angle determined hereinabove to the variable valve timing setpoint (step CJ). The fault warning light can therefore be switched off because the former fault has been corrected by the variable valve timing controller.

If the learnings differ by more than approximately one lower threshold angle comprised between 2 and 6° CRK, for example 5° CRK, it may be concluded that the actuator is jammed (comparisons in steps NL4, respectively NL3, by an actuator-jammed determination module M4, and conclusion in step VS1 in FIG. 2 by a jammed-concluding module M4a, respectively).

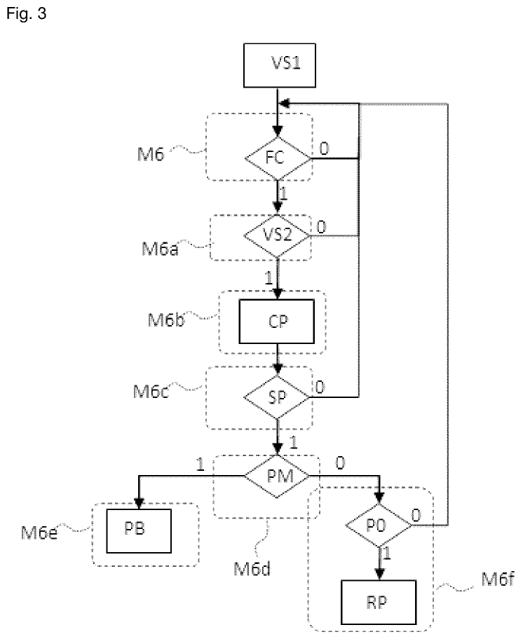

With reference to FIG. 3, an aspect of the invention also makes it possible to verify if self-rectification has occurred when the electrical variable valve timing actuator VTA1 has been jammed.

To do that, the actuator VTA1 will be controlled during certain phases where it does not need to be activated, such as for example when the injection of fuel has been cut off or the driver has lifted their foot off the throttle pedal, thus inhibiting injection. The corresponding method step is a step FC of verifying the supply of fuel and is executed by a fuel-injection cut-off evaluation module M6. If the supply has been cut off (scenario 1, which is to say “true”, in FIG. 3), then the method continues to the next step (step VS2 in FIG. 3), which is executed by a jam-verification module M6a. In the negative (scenario 0, which is to say “false”, in FIG. 3), the method then returns to the start of step FC.

During this phase of halting or cutting off the supply of fuel, the position of the teeth of the camshaft target will be monitored. This may be described as a jam-verification step VS2 for verifying if the actuator is jammed, for example if it is stable as explained above. If the actuator is jammed (scenario 1), then the method continues to the next step (step CP). In the negative (scenario 0), the method then returns to the start of step FC. This step VS2 is executed by a jam-verification module M6a to verify if the variable valve timing actuator VTA1, VTA2 is jammed.

During the control step CP, the control system will be regulated until it converges toward an actuator shift for actuator VTA1 that is equal to the last adaptive position value to which a chain jump is added, defined as being a setpoint value. This control step CP is executed by a control module M6b to command a movement of the variable valve timing actuator VTA1, VTA2 by a chain-jump angle corresponding more less to a distance separating two teeth on the timing sprocket with which the timing chain engages.

The method continues with a position-verification step SP executed by a position-verification module M6c to verify if the position of the variable valve timing actuator VTA1, VTA2 has been modified by the movement. In this step SP, when this setpoint is reached, the command setpoint for the actuator VTA1 is compared against a theoretical setpoint that is supposed to generate this setpoint value, in order to conclude whether or not the chain jump is still present. If the position has changed (scenario 1), then the method continues to the next step (step PM) executed by a shift-verification module M6d to verify if the position has varied by more or less said chain-jump angle. Stated differently, this involves verifying if the position has varied, in terms of absolute value, by a value approximately equal to the chain-jump angle (the command value used in M6b). What is meant by approximately is with a margin of error of less than 10%. In the negative (scenario 0), the method then returns to the start of step FC.

The step PM executed by the module M6d is a step of verifying the shifting of position in order to determine if the position of the actuator VTA1 has varied by more or less said chain-jump angle.

The affirmative (scenario 1) leads to a step PB of concluding that the actuator VTA1 has a non-jammed status, this step being executed by a not-jammed concluding module M6e to conclude that the variable valve timing actuator VTA1, VTA2 is no longer jammed, but does have a persisting problem.

In the negative (scenario 0), a step P0 is implemented to determine if the position of the actuator VTA1 has returned to a former learned value, this step P0 being executed by a self-rectified-concluding module M6f to conclude that the variable valve timing actuator VTA1, VTA2 has rectified itself, in instances in which the position has not varied by more or less said chain-jump angle, and the position has returned to a former learned value. If the outcome of step P0 is negative (scenario 0), the method then returns to the start of step FC.

If the outcome of step P0 is affirmative (scenario 1), a step RP of concluding that the actuator VTA1, considered as having rectified itself, has a non-jammed status is performed, this step RP being executed by the self-rectified-concluding module M6f. Specifically, if the jam disappears, that means that the former problem stems from an actuator that has rectified itself. If not (step PB), the problem stems from a true chain jump, and the information will therefore assist in the repair to resolve the problem.

In order to verify if the chain jump is real, an angular setpoint for the actuator is requested in order to confirm the diagnosis, for example 6° CRK or, more generally, between 0-12° CRK.

The idea is to verify if the true actuator setpoint needs 6 or 18° CRK in order to reach this position so as to confirm, or otherwise, that the camshaft target tooth is unjammed.

An aspect of the invention also relates to a computer program comprising program code instructions for carrying out steps of the control method as described hereinabove, when said program is run on a computer. The program can be loaded into an on-board computer or a dedicated computer-operated control system, of a motor vehicle.

Another subject of the invention is a motor vehicle comprising a control system as described hereinabove.

1. A system for controlling variable valve timing for a motor vehicle mechanical system comprising one or more camshafts connected to a crankshaft and one or more variable valve timing actuators each associated with a respective camshaft, the control system comprising:
a position-learning module (M1) for determining, for each camshaft, positions of teeth of a corresponding camshaft target,
a stability-estimating module for determining, for each variable valve timing actuator, whether said actuator has been in a stable setpoint position for a given length of time,
a learnings comparison module for determining, for each variable valve timing actuator situated in the stable setpoint position for a given length of time, whether a new determination of the positions of teeth of the target of the corresponding camshaft has become offset with respect to a former determination of said positions by an offset angle greater than a chain-jump angle,
a weighted-learnings comparison module for determining, for each variable valve timing actuator not situated in the stable setpoint position for a given length of time, whether a new determination of the positions of teeth of the target of the corresponding camshaft to which a new actuator setpoint has been added has become offset with respect to a former determination of said positions of teeth of the target of the corresponding camshaft to which a former actuator setpoint had been added by an offset angle greater than the chain-jump angle, taking the velocity of the variable valve timing into consideration,
a chain jump-compensating module for adding the offset angle to the new actuator setpoint, for each variable valve timing actuator and when the new determination of the positions of teeth is offset by an offset angle greater than the chain-jump angle,
an actuator-jammed determination module employed, for each variable valve timing actuator and when the new determination of the positions of teeth is offset by an offset angle smaller than the chain-jump angle, to determine whether said offset angle is greater than a lower threshold angle,
a jammed-concluding module connected to the actuator-jammed determination module, to conclude that the variable valve timing actuator has jammed if the offset angle is greater than said lower threshold angle,
when there are several camshafts, a chain-jump locating module, using the respective offset angle for each camshaft to locate the chain jump, the chain jump being located:
on the camshaft associated with an offset angle greater than the chain-jump angle, with the other camshaft(s) respectively being associated with an offset angle less than the chain jump, or
on the crankshaft-when there are several camshafts all associated with an offset angle greater than the chain-jump angle.

2. The control system as claimed in claim 1, wherein the chain-jump angle is comprised between 19 and 21° of crank angle.

3. The control system as claimed in claim 1, wherein the lower threshold angle is comprised between 2 and 6° of crank angle.

4. The control system as claimed in claim 1, wherein the stability-estimating module is configured to determine, for each variable valve timing actuator, that said actuator is in a stable setpoint position if the teeth are within a range of plus or minus 1 degree with respect to an actuator setpoint.

5. The control system as claimed in claim 1, wherein the given length of time is from 3 to 8 seconds.

6. The control system as claimed in claim 1, further comprising:
an engine-cylinders fuel-injection cut-off evaluation module, for evaluating whether a phase of cutting off the injection of fuel has been reached,
a jam verification module, for verifying, when it has been determined that a phase of cutting off the injection of fuel has been reached and for each variable valve timing actuator, whether said variable valve timing actuator has jammed,
a control module for commanding, for each variable valve timing actuator, a movement of said variable valve timing actuator through a chain-jump angle corresponding more or less to a distance separating two teeth on the timing sprocket with which the timing chain engages,
a position-verification module for verifying, for each variable valve timing actuator, if the position of said variable valve timing actuator has been modified by the movement,
a shift-verification module, for verifying, for each variable valve timing actuator for which it has been determined that the position has been modified by the movement, if the position has varied by an amount approximately equal to the chain-jump angle,
a not-jammed-concluding module, for concluding that the variable valve timing actuator is no longer jammed but that a problem persists, in the event that the position has varied by an amount approximately equal to the chain-jump angle,
a self-rectified-concluding module, for concluding that the variable valve timing actuator has rectified itself, in the event that the position has returned approximately to an earlier learned value.

7. A method for controlling variable valve timing for a motor vehicle mechanical system comprising one or more camshafts connected to a crankshaft and one or more variable valve timing actuators each associated with a respective camshaft, the control method comprising:
a learning step for determining, for each camshaft, positions of teeth of a corresponding camshaft-target,
a stability-estimating step for determining, for each variable valve timing actuator, whether said actuator has been in a stable setpoint position for a given length of time,
a learnings-comparison step for determining, for determining, for each variable valve timing actuator not situated in the stable setpoint position for a given length of time, whether a new determination of the positions of teeth of the target of the corresponding camshaft has become offset with respect to a former determination of said positions by an offset angle greater than a chain-jump angle,
a weighted-learnings comparison step for determining, for each variable valve timing actuator not situated in the stable setpoint position for a given length of time, whether the new determination of said positions of teeth of the target of the camshaft to which a new actuator setpoint has been added has become offset with respect to a former determination of said positions of teeth of the target of the corresponding camshaft to which a former actuator setpoint had been added by an offset angle greater than the chain-jump angle, taking the velocity of the variable valve timing into consideration,
a chain-jump compensation step, for adding the offset angle to the new actuator setpoint, for each variable valve timing actuator and when the new determination of the positions of teeth is offset by an offset angle greater than the chain-jump angle,
an actuator-jammed determination step employed, for each variable valve timing actuator and when the new determination of the positions of teeth is offset by an offset angle smaller than the chain-jump angle, to determine whether said offset angle is greater than a lower threshold angle,
a jammed-concluding step, for concluding that the variable valve timing actuator has jammed if the offset angle is greater than said lower threshold angle,
when there are several camshafts, a chain-jump location step using the respective offset angle for each camshaft to locate the chain jump, the chain jump being located:
on the camshaft associated with an offset angle greater than the chain-jump angle, with the other camshaft(s) respectively being associated with an offset angle less than the chain jump, or
on the crankshaft when there are several camshafts all associated with an offset angle greater than the chain-jump angle.

8. The control method as claimed in claim 7, further comprising:
an engine-cylinders fuel-injection cut-off evaluation step for evaluating whether a phase of cutting off the injection of fuel has been reached,
a jam verification step for verifying, when it has been determined that a phase of cutting off the injection of fuel has been reached and for each variable valve timing actuator, whether said variable valve timing actuator has jammed,
a control step for commanding, for each variable valve timing actuator, a movement of said variable valve timing actuator through a chain-jump angle corresponding more or less to a distance separating two teeth on the timing sprocket with which the timing chain engages,
a position-verification step for verifying, for each variable valve timing actuator, if the position of said variable valve timing actuator has been modified by the movement,
a shift-verification step for verifying, for each variable valve timing actuator for which it has been determined that the position has been modified by the movement, if the position has varied by an amount approximately equal to the chain-jump angle,
a not-jammed-concluding step, for concluding that the variable valve timing actuator is no longer jammed but that a problem persists, in the event that the position has varied by an amount approximately equal to the chain-jump angle,
a self-rectified-concluding step for concluding that the variable valve timing actuator has rectified itself, in the event that the position has returned approximately to an earlier learned value.

9. A vehicle comprising a control system as claimed in claim 1.

10. The control system as claimed in claim 2, wherein the lower threshold angle is comprised between 2 and 6° of crank angle.

11. The control system as claimed in claim 2, wherein the stability-estimating module is configured to determine, for each variable valve timing actuator, that said actuator is in a stable setpoint position if the teeth are within a range of plus or minus 1 degree with respect to an actuator setpoint.

12. The control system as claimed in claim 3, wherein the stability-estimating module is configured to determine, for each variable valve timing actuator, that said actuator is in a stable setpoint position if the teeth are within a range of plus or minus 1 degree with respect to an actuator setpoint.

13. A vehicle comprising a control system as claimed claim 6.
